(19) United States
(12) Patent Application Publication
(10) Pub. No.: US 2005/0071185 A1
(43) Pub. Date: Mar. 31, 2005

(54) Regulatory compliance evaluation system and method

(76) Inventor: Bradley Merrill Thompson, Zionsville, IN (US)

Correspondence Address: BAKER & DANIELS, 300 NORTH MERIDIAN STREET, SUITE 2700, INDIANAPOLIS, IN, 46204-1782, US

(21) Appl. No.: 10/913,843

(22) Filed: Aug. 6, 2004

Related U.S. Application Data
(60) Provisional application No. 60/493,307, filed on Aug. 6, 2003.

(51) Int. Cl. G06F 17/60

(52) U.S. Cl. 705/1

(57) ABSTRACT

The present invention involves a system and method for producing a quantitative and precise assessment of overall compliance with the laws and regulations administered by a regulatory organization by using data obtained from and produced by that agency. This system and method for assessing regulatory compliance comprises several steps. One step involves obtaining audit information relating to the business entity. Another step involves interviewing personnel of the business entity and recording interview information, either personal or written interviews. Also, regulatory information is obtained relating to inspection of the business entity by the corresponding agency. Regulatory quality data is also obtained from the company, the corresponding agency, and other companies within the industry. Finally, the audit, interview, inspection, and regulatory quality information is combined and scored to create a compliance index related to the efficiency of the regulatory compliance of the business entity and then identifying any more general risk factors for that company. A machine-readable program storage device stores encoded instructions for normalizing a company's compliance assessment and calculating, evaluating, analyzing and conducting subanalysis on a company's and the industry's relative degree of compliance.

### BACKGROUND OF THE INVENTION

1. Field of the Invention

The invention relates to the management of compliance in regulated industries. More specifically, the field of the invention is that of regulatory compliance evaluation for the pharmaceutical, medical device, and biological product industries.

2. Description of the Related Art

A pharmaceutical, medical device or biological product company's relative compliance risk related to the laws administered by the U.S. Food and Drug Administration (“FDA”), including all pre-market, marketing, manufacturing and other post-market requirements is a strategically vital assessment. While accounting scandals have rocked industry generally, the drug, medical device, and biological product manufacturing industries have suffered from compliance problems. Corporate boards are looking for ways to fulfill their responsibility of compliance oversight.

For years, companies have struggled to accurately assess their overall level of compliance with the laws and regulations administered by the U.S. Food and Drug Administration. To butcher a common metaphor, while companies have known how to assess the individual trees of compliance (that is, the compliance of a particular operation with a specific regulation), they have lacked tools to determine what the whole forest looks like. And yet, company leaders are legally obligated to assess the forest as a whole to fulfill their corporate responsibilities.

Not only do corporate boards have a legal responsibility to assess and oversee the company's overall level of compliance, senior management needs to keep a watchful eye over all compliance to avoid costly FDA enforcement actions. Companies engage in risk assessment and business planning for a wide variety of possible risks, and FDA compliance should be among those risks assessed.

In addition, companies routinely must decide whether to make substantial investments in programs that will affect the level of compliance the company achieves. In most areas, when a company makes a substantial investment, the company likes to identify a metric to determine whether the investment achieves its intended purpose. That measurement is important so that the company can assess the wisdom of future, related investments, and indeed whether to continue the original investment. For example, if the company is going to adopt a new web-based quality assurance training program company-wide, the company probably would like to know the degree of compliance before and after adopting the program to measure its benefit.

### SUMMARY OF THE INVENTION

The present invention is a compliance evaluation system and method that provides a metric for guiding corporate management in FDA-regulated industries.

From a management standpoint, a valid compliance metric would also give the CEO a tool to use with employees who have a compliance function to measure their performance and to motivate them further. Companies routinely use profitability measures and other metrics to motivate employees to pull together as a team to achieve a common goal. A compliance metric would likewise give managers a tool to motivate employees to make sure that compliance gets its fair share of attention.

There is an important philosophical debate about what a compliance metric should measure. On the one hand, from a legal and ethical standpoint, the company really only needs to know whether it is driving within the speed limit, i.e., whether it is complying with FDA laws and regulations. That is basically a binary question—either it is or it is not. Moreover, there is a practical reason for also wanting to know whether, in a 55 mile an hour zone, the company is driving 57 mph or 87 mph. Neither of those is lawful, but one of them is certainly more serious than the other. Indeed, in most states they are different offenses that have different penalties. As a result, there is a need for more information than a mere yes/no answer to the question of whether the company is in compliance. The magnitude of any noncompliance is important.

In addition, in a large company with many operating units, assessing the compliance of every operation with every requirement is impossible. Indeed, in any given year it is only possible to directly measure compliance in a very small fraction of the company's operations and with regard to only a small fraction of the laws that apply. Thus, as a surrogate for measuring compliance directly, for those large companies, an index can only extrapolate the degree of compliance found in a sample of the operations, and can also examine the degree to which the company has adopted effective systems to ensure compliance more generally. For this reason, a scale of compliance is needed rather than a binary answer.

Beyond using a scale, some companies would also want to know how fast the traffic is driving around them. But, in another analogy, there is some question about whether compliance, like a school exam, should be graded on an absolute scale or on a curve. An absolute scale has the advantage of reflecting the nature of the law (as opposed to the nature of enforcement). This is because the law is an absolute scale, where an individual company's performance is assessed only with regard to whether that company's conduct meets the statutory test.

On the other hand, a metric that is more analogous to grading on a curve over time would give companies an incentive constantly to improve. Companies below the average would have an incentive to raise their own level of compliance, which in turn brings the overall average up. Moreover, companies that are near or above the average level of compliance would not want to rest on their laurels as companies around them work to improve their compliance. Simply put, a metric that grades on a curve would use competition to enhance the industry's level of compliance.

Finally, in many cases in the FDA regulatory world, neither is the speed limit defined exactly, nor is there a radar gun that with great precision can measure compliance. To have the absolute scale, we would need a very precise statute that sets the speed limit and a radar gun that could precisely measure the company's compliance. The fuzziness around the edges of the FDA's laws makes comparisons to other companies an important benchmark.

The present invention incorporates the following unique features in response to the above-described needs of the regulated industry:

1. The index produces a quantitative—and more precise—assessment of overall FDA compliance (all other assessments a consultant currently might offer are qualitative—e.g. you have achieved a “high level of compliance”).

2. The index is built in large part on data obtained from FDA such that the index characterizes the seriousness of the noncompliance in FDA's eyes.

3. The index program, over time, will produce a robust database that will allow meaningful comparison of company compliance to an industry norm. Indeed, the scores will be normalized to tell a company in which quartile of compliance the company currently finds itself.

The present invention, in one form, relates to an evaluation method for assessing regulatory compliance involving audit information, personnel interviews, and regulatory which is combined and scored to create a compliance index.

Another aspect of the invention relates to a machine-readable program storage device for storing encoded instructions for a method of normalizing a company's compliance assessment and calculating, evaluating, analyzing and conducting subanalysis regarding a company's and the industry's relative degree of compliance with the laws and regulations administered by the U.S. Food and Drug Administration according to the foregoing method.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic diagrammatic view of the data collection procedures of the present invention.

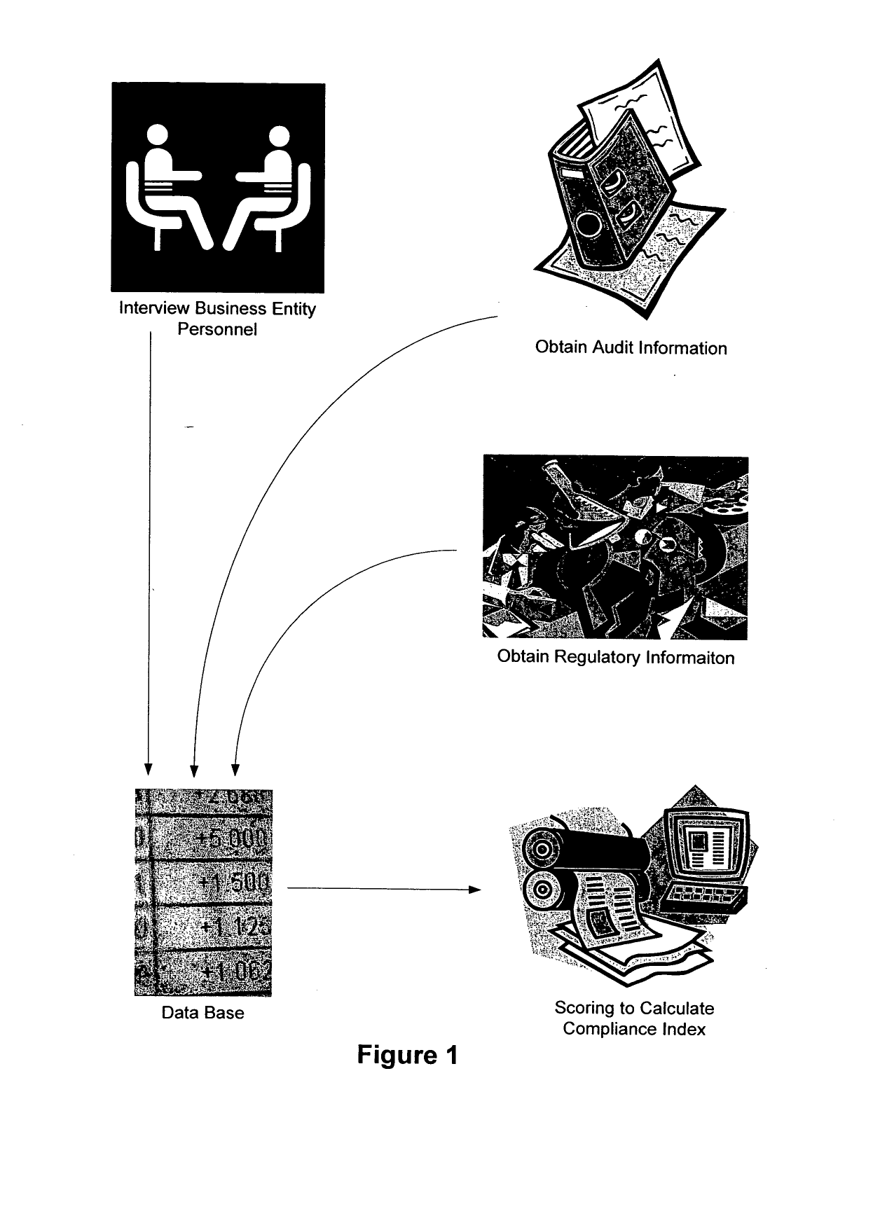

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

The detailed descriptions which follow are presented in part in terms of algorithms and symbolic representations of operations on data bits within a computer memory representing alphanumeric characters or other information. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. At some times, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, information, or the like. It should be borne in mind, however, that all of these and similar terms are to be associated with the appropriate physical quantities and are merely used here as convenient labels applied to these quantities. The algorithm itself, while capable of being implemented in a computer or other device, represents a business method capable of performance without such a physical device.

Further, the manipulations performed are often referred to in terms, such as comparing or adding, commonly associated with mental operations performed by a human operator. No such capability of a human operator is necessary, or necessarily desirable in every cases, in any of the operations described herein which form part of the present invention; the operations may be organizational or machine operations. Useful machines for performing the operations of the present invention include general purpose digital computers or other similar devices. In all cases the distinction between the method operations in operating a computer and the method of computation itself should be recognized. The present invention relates to a method and apparatus for operating a business method, and may or may not include computer in processing electrical or other (e.g., mechanical, chemical) physical signals to generate other desired physical signals.

The present invention also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus. In particular, various general purpose machines may be used with programs written in accordance with the teachings herein, or it may prove more convenient to construct more specialized apparatus to perform the required method steps. The required structure for a variety of these machines will appear from the description below.

In the following description, several terms which are used frequently have specialized meanings in the present context. The terms “company”, “corporation”, and “business entity” mean a specific legal entity which represents the organization for the associated pharmaceutical, medical device, and/or biological product which relates to a regulated industry. The term “business unit” refers to an operating organization that is separately accounted for, which may be a subset of a legal entity, or which may be an amalgamation of several legal entities. The term “regulated industry” refers to an industry which is subject to the oversight of a third party, such as a government agency or a non-governmental standards organization, but which is responsible for certifying or at least checking the operations of the company for compliance with the applicable legal rules or regulations, and/or industry standards that are governed by the standards organizations. The present invention is described below in relation to the United States Food and Drug Administration (or “FDA”), and is specifically tailored to the rules and regulations promulgated by the FDA. It is also possible that the following evaluation method is implemented in relation to certification by the International Organization for Standardization (or “ISO”) such as ISO 9000 or 14000. Although the following description details such systems and methods in terms of FDA criteria and procedures, the present invention may be practiced with other industries dealing with other regulatory agencies or standards organizations.

Many terms related to the FDA are used in this description. The term “establishment inspection report” or “EIR” means a report that is prepared by FDA after inspecting an establishment registered with FDA. The term “medical device report” or “MDR” means a report prepared by a company for submission to FDA reporting an adverse event related to the company's product. The term “investigation device exemption” or “IDE” means an exemption that allows a medical device that is the subject of a clinical investigation or research to be used in such investigation or research in order to collect safety and effectiveness data required to support a premarket approval application or a premarket notification submission to FDA. The term “premarket notification submission” or “510(k)” means a premarket submission made to FDA to demonstrate that a device to be marketed is as safe and effective, that is, substantially equivalent, to a legally marketed device that is not subject to premarket approval. The term “premarket approval” or “PMA” means the FDA process of scientific and regulatory review to evaluate the safety and effectiveness of certain classes of medical devices. The term “good manufacturing practices” or “GMP” means the requirements set forth in the quality system regulation that require medical device manufacturers to have a quality system for the design, manufacture, packaging, labeling, storage, installation, and servicing of finished medical devices intended for commercial distribution in the United States.

Recently, in response to the need for a compliance metric, the MedTech Regulatory Compliance Index (the “index”) was launched. The purpose of the index is to assess a pharmaceutical, medical device or biological product company's relative degree of compliance and associated risk related to the laws administered by FDA, including all premarket, marketing, manufacturing and other post market requirements. The index is intended to measure the degree of compliance at a high level to aid senior management and board committees who wish to monitor their company's compliance efforts over time.

The index seeks to identify a variety of surrogate markers designed, on average, to accurately estimate the degree of compliance for a company over time. Like the various stock market indices and economic indices, the index is only a surrogate. But also like other indices, the elements that form its basis are designed to be representative of the overall forest of compliance. Through standardization of its individual elements, the index works to establish a reliable barometer of a company's compliance over time, and a basis for comparing the degree of compliance among companies in an industry.

Mathematically, the index attempts to put any noncompliance in the perspective of FDA to establish the gravity of the noncompliance. This is necessary so that a single index can compare different types of noncompliance. For example, if in a fleet of 100 cars, all 100 are driving 60 mph in a 55 mph zone, is that more or less noncompliance than a fleet of 100 cars in which 10 are driving 100 mph and 90 are driving within the speed limit? The only way to compare such different situations through a single index is to weight data based on the severity of noncompliance in the eyes of the regulator. The index thus relies on a large database of historical FDA enforcement actions, updated regularly, to establish the weighting. As a result, in that sense, the index measures a combination of the degree or volume of noncompliance relative to other companies in the industry and the likelihood of FDA enforcement action.

The index is a composite of data from four general sources: (1) prior company audits, (2) company compliance interviews, (3) FDA inspection assessments, and (4) regulatory quality data. The present invention breaks down the elements of those general sources into a calculation of separate data points that are then scored to a uniform method of calculation. Each category, and the corresponding method of calculation for that category, is explained below.

Prior company audits. By regulation, companies are required to periodically audit key functions. They audit these functions using company personnel, outside consultants, or both, and they usually perform them annually. These audits might cover such areas as design controls, clinical trials, corrective and preventive actions, complaints, medical device reporting and management controls. Additionally, in the auditing world, the observations that come out of these audits can be grouped into “major observations” and “minor observations.” The index calculation requires that those audits be examined, the observations be categorized as major or minor, and the total of the auditing observations be calculated based on weighted averages that reflect the relative importance of the audit subject. With regard to the collection of the audit data, one of the features of the index that is designed to facilitate efficient collection and meaningful evaluation of data is a standardized audit report form for internal audits. To ensure compliance with FDA requirements, FDA-regulated companies today may each conduct hundreds of internal compliance audits every year. But as between companies, and sometimes even within a single company, those audits collect differing categories of information. The audit reports also use terms like major and minor observations in different ways. These differences prevent the data in these reports from being aggregated in any truly meaningful way to assess the company's state of compliance with FDA requirements. In addition to irregular categories of information, the quality of the written audit reports varies widely. Many reports are missing information needed for the report to be useful (for example, the date, the facility audited, etc). Others do not include enough information to enable evaluation of whether the underlying audit was vigorous or not.

To eliminate this inconsistency and to allow aggregation and benchmarking of data, the index may incorporate a template for audit reports. The template seeks to incorporate all of the best auditing practices, or generally accepted compliance principles (“GACPs”), while at the same time remaining practical for widespread use. The design of the template allows meaningful aggregation of the data collected. The draft template is accompanied by guidance on the definitions of critical, major, and minor observations, as well as a system of enhanced FDA observation codes. A further enhancement for data entry, processing, and feedback is an optional , an online service that permits auditors to complete their reports using a secure web site. This online capability offers some important features. First, it makes the use of the observation codes easier because it allows the user to search for terms in the code descriptions, pull up the potential codes and simply drop the right one in rather than retype it. The narrative portion of the report can be filled out with easy access to the accompanying guidance on observations. The potential for incomplete data reporting is reduced by programming the server to require completion of all mandatory fields before accepting an audit report. When complete, the auditor can e-mail the completed report to whomever needs a copy and print out hard copies as necessary. To facilitate acceptance among the community of users the on-line audit template is designed to be compatible, with many leading audit management information technology systems. Consequently the compatibility, enables a user may import information from the GACP template into its own audit management software or export information contained in its audit management software into the template.

Selected fields of data are compiled in company-specific and industry databases for use in benchmarking. The quality of the audit may be evaluated by trained consultants who will read the report and grade its quality (that is, the quality of the written report and by implication the quality of the underlying audit) according to established criteria. If the audit report quality grades awarded by the two different consultants differ by more than a selected value, the audit report will be delivered to a third auditor for resolution of the variance. When the grading process is complete, the system may notify for example by e-mail, a pre-designated individual any time an audit report receives a failing grade. The data entered into the industry database may be proportionately discounted if it comes from a report that receives less than a satisfactory grade.

Many benefits will inure to companies who use the audit template. The first is compliance management. The compiled database for the audited enterprise and the industry data base can be available to an enterprise for use in their daily compliance management and benchmarking of improvements. The entity specific databases and industry databases may be used by an entity to identify (a) trends across the audited entity in terms of observations, and (b) areas of the entity—geographic as well as quality subsystems—that could benefit from further evaluation. A second key benefit is that the database will allow automatic comparison of the audit results in three ways: Intra-entity; Inter-entity using the industry database; and with the FDA Turbo EIR data obtained from Agency inspections. A further benefit is the rapid update of an entity's overall index score. Rapid update enables entities to effectively monitor their compliance levels over time, if desired, even daily. The pervasive use of these audit report templates should enhance the quality of the underlying audits. Also, having an objective process for assessing the quality of audit reports gives the entities employing the auditors a basis for identifying which auditors need further training.

With regard to the method of calculation, prior company audit data may be accorded a significant percentage of the overall index, for example, thirty five percent (35%) may be a fair portion. Prior audits receive the most weight because the best source of compliance data is the company's own organized assessments. Although this may vary depending on quality, scope and number, audit data will typically be broad in scope and one of the most reliable barometers of a company's compliance. Other variables may be combined with such prior auditing to better assess the scope, quantity and quality of the audits. For example, several relevant variables may be assessed: Does the company conduct clinical trials? If so, what percent of revenue is attributed to sales of products that have undergone clinical trials? Does the company manufacture its own products? If so, what percent of revenue is attributed to sales of products that it manufactures? What audits has the company or its consultants conducted over the last three years?

With answers to those questions, the method then assigns relative weights to the auditing areas. For example, for device operations within the company subject to the index, the following weights may apply: Design controls may be allocated, for example, twenty to thirty percent (20-30%) depending on the percent manufactured (Design controls represent the biggest risk factor because of the strong relationship between design methods and recalls and adverse product issues. FDA compiled data for a period of four (4) years through its recall database that demonstrated that forty-five to fifty percent (45 to 50%) of all recalls stemmed from poor product design.). Clinical trials may be allocated, for example, zero to thirty percent (0-30%) depending on the percent trialed (Clinical trials represent the second largest risk factor for two reasons. First, the importance of clinical studies for new technologies has been steadily increasing in recent years. Second, at the same time, clinical data integrity failures are on the rise. In 2001, FDA reported that forty percent (40%) of clinical trial sponsors failed to ensure proper monitoring of their clinical investigation sites and fifty percent (50%) failed to ensure overall clinical investigation compliance.). Corrective and Preventative Action system data (“CAPA”) may be allocated, for example, ten to twenty percent (10-20%) depending on the technical complexity of the company's products (CAPA represents the third largest risk factor because of FDA's emphasis on CAPA as the one of the most important quality system elements. The Quality System Subsystem Inspection Technique (“QSIT”) requires a review of the CAPA system, even in the most abbreviated inspection of medical device manufacturers. Further, FDA reports that thirty percent (30%) of the top EIR observations of medical device manufacturers related to the firms Corrective and Preventive Action system.). Complaints and MDRs may be allocated, for example, ten to fifteen percent (10-15%) (Complaints and MDR represent the fourth largest risk factor because the MDR regulations provide mechanisms for FDA and manufacturers to identify and monitor significant adverse events involving medical devices. The goals of the MDR regulations are to detect and correct problems in a timely manner.). Management controls may be allocated, for example, from five to ten percent (5-10%) (Management controls represent the fifth largest risk factor because FDA reports that forty percent (40%) of the top EIR observations of medical device manufacturers related to the firms' management controls. Additionally, when inspecting medical device manufacturers, FDA field personnel are trained to begin and end each inspection with a review of the firm's management controls.). Finally, companies may audit additional areas as well, and those audit results should also be considered. For example, companies with pharmaceutical or biologic operations may audit different areas, and the relative weights of the audits may need to be adjusted because of this. In general, the weight that is allocated to additional audits will depend on the company's main activities.

When compiling the data for company audits, these various elements should be accumulated for each business unit or entity (as appropriate). For any areas not audited within the last year, the score may be as little as zero depending on the nature of the industry and the importance of that element to the business being evaluated. For all audits conducted, their quality, scope and outcome will be assessed and scored. For example, the quality and scope of the auditing may be rated by a factor of 0 to 1, in 0.1 increments (This is a unitary measurement, not a midline measurement. In other words, the average is not 0.5. Audits should be evaluated in terms of both scope and quality, and if adequate in both areas the audit may receive a score of 1.). The outcome of the audit may also be rated between 0 and 1 to reflect the overall degree of compliance found, following the following guidelines (this also is not a midline score): Subtract 0.1 for each major observation; subtract 0.02 for each minor observation. The score for each audited area is calculated by multiplying the percentage weight for the particular audit area, the quality and scope score for the audit, and the outcome score for the audit. A business unit's audit score is equal to the sum of all audit scores for each audit area.

A similar analysis may be made on a company or corporate level (Although there is not an explicit regulatory requirement for “corporate” auditing, most companies interpret the quality audit requirement in the quality system regulations to impose some form of corporate auditing requirement on the company.). Corporate audits of business units should have a substantial portion of this element, for example about fifty percent (50%). Another major element of the corporate level audit, allocated for example about thirty percent (30%), relates to management review and/or trending (an audit of corporate functions of management). Finally, with regard to medical device operations within a company, another element, allocated for example twenty percent (20%), involves a corporate audit of the CAPA function. The corporate audits of business units are scored the same way audits of business units are scored; however, the components of the scoring of management reviews/trending and CAPA audits are treated as “binary” scores. That is, companies that conduct these audits will receive a higher corporate audit score, but companies that do not conduct these types of audits will not be penalized.

For the total audit subscore, an average of the scores for each business unit is calculated, and corporate is weighted as about twenty-five percent (25%) (Corporate has the broadest perspective with regard to the entire company's compliance, and the effectiveness of corporate functions is a major determinate for compliance by the rest of the company, hence the significance of the weight.). This score may be converted to a quartile scale.

Company compliance interviews. Company audits, while important, do not tell the whole story by any means. For example, most auditing focuses on the quality system, and leaves unexamined other important regulatory compliance topics like data integrity and marketing claims. To capture this other data, as well as softer issues like the company's incorporation of best practices in the compliance area and the company's overall compliance culture, the index utilizes a survey of individuals within the company who have compliance responsibilities. The survey takes two forms. First, there is a written questionnaire that addresses known or suspected noncompliance shortcomings, adoption of best practices, compliance culture and the status of the company's relationship with the regulatory organization. The questions are combined on the basis of relative weights. Second, there is an oral interview with those who responded to the written questionnaire in order to drill down more deeply into the issues raised by the questionnaire.

Company compliance interviews provide a significant portion of the evaluated data, for example about twenty-five percent (25%) of the index value (While auditing focuses on compliance with specific requirements of the quality system regulations, there is much more to compliance. For example, auditing does not evaluate many best practices, as well as softer types of information such as the company's relationship with the regulatory organization and company culture. Moreover, there are likely to be whole segments of the company that the company does not audit, but which managers know present compliance challenges, such as data integrity and marketing claims.). To obtain reliable data for this component, statistical sampling techniques may be used. For example, the number of interviewees should typically be at least three and should reflect a balance between regulatory and quality compliance. The interviews may include all compliance personnel, or at least one from each division within the company, as well as from corporate regulatory and quality. The subject of the written questionnaire and oral interview should include (with exemplary percentages): Known or suspected compliance shortcomings (50%) (Known and suspected compliance shortcomings receive the highest weight because this factor bears directly on risk of enforcement.); Adoption of best practices (20%) (Best practices receive the second highest weight, because aside from knowledge of a specific compliance issue, our experience has shown that the strength of the best practice adoption is a key indicator of compliance. For example, the Federal Sentencing Guidelines that apply to convicted organizational defendants provide that part of a sentencing court's consideration is whether an organization had an “effective program to prevent and detect violations of law,” which means a program that is reasonably designed, implemented, and enforced so that it generally is effective in preventing and detecting criminal conduct.); Compliance culture (20%) (Although a company's culture is not easily measured, this factor is nevertheless a crucial determinant of whether a company's employees will work toward compliance.); and Relationship with the regulatory organization (10%) (This receives the lowest weight because, although an important risk factor, it is less important than actually achieving compliance. Nonetheless, most companies have some area of noncompliance, and their relationship with the regulatory organization may well determine whether the organization challenges them.).

The written questionnaire may include the statements to be assessed and answered by the respondent on a scale of that corresponds to numerical data points ranging from 1 to 7, which, for the respondent, corresponds to a range of written descriptions: Strongly Agree, Neutral/Don't Know, and Strongly Disagree. The following are examples of questions for a written questionnaire for the device operations of an FDA-regulated company:

Compliance Statements: My company's compliance has improved from where it was 5 years ago. My company's compliance is better than other companies about the same size that make similar products. My company has areas where it needs to improve its compliance. My company's compliance needs to be improved significantly. My company has problems with compliance that it seems unable to resolve. My company's quality system covers the clinical trial function. All unapproved products being tested in clinical trials have an approved investigational device exemption, if required by regulation. When my company sponsors a clinical trial, it ships the product being investigated only to participating investigators. In clinical trials in which my company is the sponsor, it has obtained a signed agreement from each investigator participating in the study. My company conducts investigations on all unanticipated adverse device effects arising out of its clinical trials. My company terminates all clinical trials when an unanticipated adverse device effect presents an unreasonable risk to trial subjects. My company has a well-developed system for ensuring its compliance with record-keeping and reporting requirements relating to clinical trials it sponsors. My company always reports reportable events that occur in clinical trials that it sponsors. My company monitors all clinical trials that it sponsors to ensure compliance with IDE regulations. The labeling of my company's investigational devices does not make any claims about the safety and effectiveness of the device. My company does not promote or test market investigational products. My company does not make a profit on its investigational products. My company always files a supplemental IDE application when a change to the investigational plan might affect the rights, safety, or welfare of the subjects or the scientific soundness of the investigation. My company always files a supplemental IDE application when new institutions or sites are added to a clinical study. Overall, my company needs to improve its compliance with regulatory requirements relating to clinical trials. My company has either an approved 510(k) application or an approved PMA on file for every product it markets, unless the product is exempted from those requirements. My company has an approved 510(k) for all products currently or formerly in commercial distribution that have been significantly changed or modified in design. When required, my company has filed a PMA supplement prior to making any change to a product that affects its safety or effectiveness. Overall, my company needs to improve its compliance with premarket regulatory requirements. My company has registered all establishments as required under regulation. My company updates its registrations annually. My company notifies FDA within 30 days of changes in ownership, corporate or partnership structure, or location of registered establishments. My company lists all products as required by regulation. My company updates its listing biannually or when a change occurs (e.g., sale of products in a new classification) as required by regulation. My company maintains a file with copies of all labeling, advertisements and package inserts, as required by regulation. Overall, my company needs to improve its compliance with respect to registration and listing requirements. My company has a strong system for ensuring that its labeling claims are within regulatory requirements. My company only promotes its products for uses that have been clearly and specifically approved by FDA. My company's labeling claims are not false or misleading in any respect. Labeling never references the establishment registration or premarket notification for the product. A lay person can use my company's products safely and for their intended purpose based on their directions for use. Executive management has established its policy, objectives for, and commitment to quality. Executive management ensures that quality policy is understood, implemented, and maintained at all levels of my company. My company's organizational structure ensures that products are designed and produced in accordance with applicable quality system regulations. Executive management reviews my company's quality system with sufficient frequency to ensure that it satisfies applicable quality system regulations. My company has established a quality plan that defines its quality practices, resources, and activities relevant to its products. My company has established quality system procedures and instructions. My company has well-developed and effective auditing procedures and polices. My company uses audit findings effectively to address compliance issues. Audits are conducted by individuals who do not have direct responsibility for the matter being audited. A report of the result of each quality audit is always made and reviewed by management having responsibility for the matters audited. My company has sufficient quality control personnel to ensure compliance with quality system regulations. My company ensures that all quality control personnel have adequate training to perform their job responsibilities. My company documents all employee training. As part of their training, employees are made aware of product defects that could occur if they performed their job improperly. My company has a strong design control system. My company has an effective process for ensuring that all design changes get any required FDA approval. My company has a strong document control system. My company reviews, approves, communicates, and maintains a record on the changes to quality control documents. My company has a strong purchasing control system. My company has procedures for identifying products during all stages of receipt, production, distribution, and installation. My company has strong production and process controls. My company integrates quality controls into the production process. My company's quality control procedures ensure that all measuring, inspection, and test equipment is maintained appropriately to ensure valid results. My company has a strong process validation system. My company has developed quality control procedures for inspections, tests, and other verification of incoming product. My company has established procedures that address how nonconforming products should be handled, including how such product should be disposed. My company has a strong corrective and preventive action (“CAPA”) system. My company often prevents quality issues from arising. My company has a strong labeling and packaging control system. My company has strong procedures to ensure that its products are handled, stored, distributed and installed appropriately. My company maintains all quality system records that are required under the quality system regulation. Overall, my company needs to improve its compliance with manufacturing-related regulatory requirements (e.g., GMPs). My company always reports MDR reportable events within the applicable timeframe. My company has written MDR procedures for internal systems and for documentation and recordkeeping requirements. My company has established and maintains MDR event files. Overall, my company needs to improve its compliance with post-market reporting obligations (e.g., MDRs or adverse drug reporting). My company timely reports to FDA actions concerning corrections and removal. My company maintains records of all corrections and removals not reported to FDA. Overall, my company needs to improve its compliance with regulatory requirements relating to corrections and removals. Where required, my company has a strong system for ensuring that its products are tracked as required by FDA regulations. My company has implemented a tracking program whenever it has been ordered to do so by FDA. My company has implemented post-market surveillance studies whenever it has been ordered to do so by FDA. Overall, my company needs to improve compliance with tracking and post-market surveillance requirements. My company has a strong system for ensuring that both internal and external documents are accurate (Several federal statutes criminalize the falsification of data ultimately given to the federal government.). There are ramifications at my company for employees who falsify data. My company rewards employees who uphold data integrity standards. Overall, my company needs to improve compliance with laws regulating data integrity.

Best Practices Statements: (Many of these questions are derived from the Federal Sentencing Guidelines that apply to convicted defendants that are organizations (the “Guidelines”). The Guidelines provide guidance and direction to federal sentencing courts when sentencing a convicted defendant. Part of a court's consideration is whether an organization had an “effective program to prevent and detect violations of law,” which means a program that is reasonably designed, implemented, and enforced so that it generally is effective in preventing and detecting criminal conduct. Additionally, “[t]he hallmark of an effective program to prevent and detect violations of law is that the organization exercised due diligence in seeking to prevent and detect criminal conduct by its employees and other agents.” Due diligence requires that the organization take seven steps in its program, and these seven steps are reflected in this and the following six categories.) My company's compliance program is effective in preventing and detecting criminal conduct by its employees (As part of an effective compliance program under the Federal Sentencing Guidelines, an organization must have established compliance standards and procedures to be followed by its employees and other agents, which are reasonably capable of reducing the prospect of criminal conduct.). My company has identified the legal requirements applicable to its operations and has translated them into understandable criteria for lawful conduct. Current government enforcement policies, priorities and initiatives receive special emphasis in my company's compliance programs. My company reviews its own history and the histories of other similar companies to identify laws that have been violated and what laws prosecutors charged in those cases. My company has identified employees who, because of their responsibilities or duties, are more likely to have opportunities for committing compliance violations. My company's standards, procedures, and controls ensure that legal requirements are followed or, if they are not followed, that undesirable conduct is detected and reported. My company's compliance program is designed to detect compliance violations by agents authorized to act on behalf of my company. My company retains the right to audit independent contractors. My company contractually requires independent contractors to adhere to a compliance program. My company has a Code of Conduct that comprehensively addresses compliance rules, ethics, and values. Compliance policies have a multi-tiered approach focused toward the subsidiaries, divisions, and departments of my company. My company's corporate policies are well-known, well understood and always followed by the various divisions of the company. My company has designated high level personnel to be responsible for compliance (Pursuant to the Guidelines, as part of the program, the organization must have assigned specific individual(s) within high-level personnel of the organization overall responsibility to oversee compliance with the program's standards and procedures.). My company's compliance program ensures that responsibility for its compliance program is in authoritative hands. When a team approach is used for compliance, direction is still ensured and necessary action is still implemented. My company has an officially designated compliance officer with responsibility for the compliance with the laws of FDA. The compliance officer is effective at his or her job. The compliance officer publicizes the elements of the compliance program such that the employees know and understand them. The Board of Directors has an audit or compliance committee. My company does not delegate substantial discretionary authority to employees known to have a propensity to engage in illegal activities (The Guidelines also specify that in developing a program, the organization must also have used due care not to delegate substantial discretionary authority to individuals whom the organization knew, or should have known, had a propensity to engage in illegal activities.). My company has a rigorous screening process for compliance personnel at their initial hiring. My company has a sufficiently rigorous screening process for personnel as promotions to positions with increased responsibilities and discretionary authority occur. In the human relations department, my company does a good job of screening employees to ensure that they are committed to achieving compliance objectives before they are hired. My company consistently reviews discretionary aspects of positions to determine whether existing checks and balances are adequate to safeguard against unwarranted discretionary authority. My company always conducts exit interviews for key compliance personnel. My company effectively communicates its standards and procedures to all employees and agents by requiring participation in training programs (The Guidelines contemplate that in order to have an effective compliance program, the organization must have taken steps to communicate its standards and procedures to be followed by its employees and other agents, for example, by requiring participation in training programs or by disseminating publications that explain in a practical manner what is required.). My company effectively communicates its standards and procedures to all employees and agents by disseminating written materials that explain what is required with respect to compliance. My company has a strong system for training new and existing employees in regulatory requirements. My company's training programs include training for both corporate and business units. My company's compliance and ethics training goes beyond narrow specialized compliance topics. My company's compliance training for its employees is meaningful. My company needs to do a better job with respect to training. My company provides ethics training to all of its employees. My company needs to do a better job with respect to ethics training. My company has trained employees on the promotional communications that they can and cannot make with respect to my company's products. Attendance at all compliance training programs is mandatory. My company is effective at integrating new hires and promotions into its compliance program. Compliance training is given as part of initial orientation. My company gives reminder training sessions at regular intervals to notify employees of changes in standards or procedures, to review the program, and to provide an opportunity for employees to raise questions. My company keeps its employees current on new regulatory developments. My company has prepared a compliance manual that outlines applicable legal requirements and established standards and procedures for compliance, including reporting mechanisms. My company's compliance manual is distributed to all employees. My company's compliance manual serves as a primary resource at training sessions. My company's compliance program is tailored to the different legal requirements applicable to, and the different skill levels of, employees in different departments. My company verifies effective dissemination of compliance program information (e.g., ending training programs with a test to assess employee understanding). My company has achieved a high level of awareness about the need for compliance among its employees. My company employs outside consultants to set up and review compliance training materials and systems. Compliance objectives are incorporated into each employee's review. Compliance is an express goal for every employee's employment objectives. My company has taken sufficient steps to achieve compliance through adequate monitoring, auditing, and reporting systems (The Guidelines require that the organization must have taken reasonable steps to achieve compliance with its standards, for example, by using monitoring and auditing systems reasonably designed to detect criminal conduct by its employees and other agents and by having in place and publicizing a reporting system for employees and other agents to report criminal conduct within the organization without fear of retribution. In addition to these practices, other companies have recognized the importance of other monitoring systems, for example, monitoring and benchmarking their competitors'compliance.). My company's monitoring, auditing and reporting systems are tailored to conduct thought to be detected. My company's monitoring and auditing systems are tailored to the persons who, by virtue of their duties, have the greatest opportunity to violate the law. My company conducts regularly scheduled and ad hoc internal reviews to assess compliance. My company uses corporate auditing or corporate compliance teams. My company regularly audits its clinical trials. In addition to in-house auditors, my company uses outside consultants to measure compliance. In my company, auditors are always independent of the personnel they are reviewing. In my company, auditors have direct access to the designated compliance coordinator. My company tracks audit findings. My company uses metrics to assess risk and impact areas. As part of its compliance monitoring, my company looks for repeat compliance violations. My company benchmarks its compliance against other similar companies. My company benchmarks its compliance against FDA norms. My company has a mechanism by which employees can comfortably and with confidence report on compliance without fear of reprisal. In my company, reporting systems ensure the anonymity of employees who report a compliance issue. My company provides access to an Ombudsman or toll free hotline for employees to anonymously report compliance or ethics concerns. All employees in my company are aware of available reporting systems. My company supports and encourages employees who report or correct compliance problems. Employees at my company are hesitant to discuss compliance issues with management. The reporting structure ensures that people with quality or compliance responsibility have independent reporting such that they are not subject to pressures of manufacturing output. Compliance standards are consistently enforced through appropriate disciplinary mechanisms, including appropriate discipline of employees responsible for the failure to detect an offense (Pursuant to the Federal Sentencing Guidelines, compliance standards must be consistently enforced through appropriate disciplinary mechanisms, including, as appropriate, discipline of individuals responsible for the failure to detect an offense. However, the appropriate form of discipline should be case specific. Not only is this principle important for employees who actually administer compliance policies and procedures, corporate and business unit leaders should also be held accountable for their actions.). Disciplinary action is consistently enforced toward those who have a responsibility to oversee and implement the compliance program, as well as those who commit an offense. My company consistently enforces its Code of Conduct with every employee and imposes appropriate sanctions where necessary. Corporate and business unit leaders in my company are accountable for compliance violations. Discipline is proportional to the offense, reflects the impact of the offense on the company, and considers other individual circumstances. After a compliance offense has been detected, all reasonable steps are taken to respond appropriately (The Guidelines provide that for an effective compliance program, after an offense has been detected, the organization must take all reasonable steps to respond appropriately to the offense and to prevent further similar offenses. This response should include any necessary modifications to its program to prevent and detect violations of law.). My company always investigates allegations of misconduct. My company reacts quickly to resolve compliance problems. When resolving compliance issues, my company addresses the problem's source. Decisions about compliance at my company (e.g., recalls, MDRs) are unbiased. After an offense has been detected, a sufficiently aggressive review of the compliance program and training systems are undertaken. After an offense has been detected, a review of the effectiveness of the compliance coordinator is undertaken. My company makes recall decisions with adequate input from all relevant disciplines within the company. My company has a well-developed plan for recalling large quantities of product, should that be necessary. A thorough compliance assessment is done as a part of due diligence for every acquisition (Although not specifically addressed by the Federal Sentencing Guidelines, an organization should be sure to perform due diligence on every company prior to an acquisition. Moreover, once the organization acquires a company, it should work to integrate that company into the fabric of the organization's compliance program. These two steps are indispensable in ensuring that a newly-acquired company does not result in enforcement actions against the acquiring organization.). My company looks at a company's regulatory submissions as a part of due diligence. Once an acquisition is complete, my company moves quickly to integrate the newly acquired company from the compliance perspective. My company has enough staff to respond effectively to compliance issues (Clearly, a company's quality department must have the resources to do its job effectively. Additionally, many companies recognize that one of the resources that helps them to achieve a high level of compliance are web-based programs for reporting and training. Although perhaps not necessary in a small company, in larger companies web-based compliance programs help to achieve consistency among corporate and business units and also help to ensure that compliance issues that develop across a company are detected as soon as possible.). My company should invest more resources in compliance initiatives. The regulatory function generally has the necessary financial and human resources to perform its function well. My company does a good job of using technology to help manage compliance, particularly with respect to web-based reporting for complaint handling and vigilance. My company uses web-based employee training programs. My company uses subject matter experts to help with difficult compliance issues. My company organizes implementation teams for significant changes in regulatory requirements (e.g., HIPAA). There is generally~good internal communication and coordination among compliance personnel (In addition to communicating standards and procedures to employees, it is also important for the corporate and business units within a company to maintain frequent communication about compliance.). Communication is well organized such that compliance best practices in one group (e.g., a business or corporate unit) are shared with other groups throughout the company. Communication between and among corporate and business units is such that a unified compliance policy is maintained for all units. Corporate units receive regular compliance reports. Business units share regular compliance reports. The Board of Directors receives a compliance update at least annually. My company has an adequate program in place to stay abreast of new regulatory developments. My company identifies new regulatory requirements early, assesses their impact, and integrates them quickly into the fabric of the company. In my company there is good alignment between compliance objectives and compensation incentives (Although the Federal Sentencing Guidelines contemplate that compliance standards will be enforced through appropriate disciplinary measures, they do not mandate that a company reward its employees for achieving a high level of compliance. Nonetheless, many companies have recognized the importance of this practice in achieving their compliance goals.). My company's bonus plans incorporate compliance metrics. My company participates in trade associations (Clearly, it is possible for a company to achieve a high level of compliance without participation in trade associations. However, many companies have recognized the value of this type of industry interaction in the pursuant of compliance. A trade association permits interaction among companies that may not occur otherwise, and therefore facilitates the exchange of tactics and practices for compliance. Additionally, often trade associations allow companies, especially small companies, to interact with FDA in a way that would not otherwise be possible.).

Company Culture Statements: (Of course, the law does not mandate a particular type of “company culture.” Nevertheless, this somewhat intangible factor is almost always a crucial element for a company that strives to achieve a high level of compliance. More specifically, a high level of compliance is more likely to be achieved when a company's management and other high-level personnel sets an example for the rest of the company. In order to set that example, management should understand and embody the company's compliance policies and should be persons who other employees can look to as role models for compliance. Overall, the goal of compliance should permeate throughout the company and should be recognized as a goal by most—if not all—employees.) My company is quality-oriented. My company encourages employees to resolve compliance problems at their source, rather than trying to “band-aid” the problems. I am confident in my colleagues' abilities and knowledge with regard to compliance. Compliance is a high priority for company management. I am confident in management's abilities and knowledge with regard to compliance. I consider management role models for compliance. Management understands the content of my company's compliance policies and procedures. Management approves policies and procedures without a full understanding of the implications of the policy or procedure. The actions of management are consistent with my company's compliance policies and missions. My company's attitude toward compliance permeates throughout all levels of my company. At all levels of my company, employees actively work toward achieving a high level of compliance. Company staff recognize the importance of compliance and have adopted the company's compliance goals as their own.

Relationship to Regulatory Organization (FDA) statements: (Like company culture, no law mandates that a company enjoy working with FDA. Indeed, it is probably possible for a company to achieve a high level of compliance without working with the agency to achieve this goal. However, most companies realize the value of having a close working relationship with the agency. In many ways, it can make reporting compliance violations easier. When FDA can trust that a company is going to come to the agency when it is experiencing compliance problems, the agency may react in a more forgiving manner when faced with these compliance violations, as it understands the company's concern for compliance. Additionally, a close working relationship will often allow the company to participate in the development of regulatory initiatives that may ultimately work in favor of the company.) My company has a close working relationship with FDA. My company has a designated FDA liaison who has a strong relationship with FDA and works directly with the agency to achieve company goals. In general, my company views FDA as its ally. When my company has a problem with a product, it seeks FDA's advice about what it should do to resolve that problem. My company is hesitant to disclose compliance problems to FDA. Approaching FDA with problems has improved my company's relationship with the agency. FDA has acted unfairly toward my company. It is difficult for my company to work with FDA to resolve problems. My company often participates in the development of new regulatory standards. My company receives more 483s than other companies our size that make similar products. My company receives more warning letters than other companies our size that make similar products. My company has access to the people we need within FDA. When my company is going through the approval process, FDA trusts my company. My company's products typically get through the FDA approval process smoothly.

“Aggravating Circumstances”. (These questions within the written questionnaire, which will be answered “yes” or “no” and will not be evaluated on a seven-point scale—reflect those factors that may greatly affect a compliance level of compliance and associated risk of an enforcement action.) My company's compliance violations directly and materially impact patient safety (When a company's noncompliance impacts the public health, this enhances the risk of an FDA enforcement action. For instance, FDA has recognized that contrary to usual procedure, repetitive or continuous noncompliance may not be a prerequisite for a judicial enforcement action when noncompliance impacts the public health.). My company's compliance violations are gross, flagrant, or intentional (FDA has recognized that these types of violations merit special attention and may even eliminate the need for certain procedural protections, such as prior warning to the violator. Additionally, the Federal Sentencing Guidelines provide that an organization's culpability for an offense can be increased if high-level personnel condoned or was willfully ignorant of an offense.). My company has falsified data. My company has tried to cover up or hide its noncompliance from FDA (The Federal Sentencing Guidelines provide that an organization's culpability for an offense can be increased if the organization obstructed justice in any way.). My company's noncompliance has been continuous or repetitive (The FDA Regulatory Procedures Manual recognizes that this is the precise type of conduct on which a criminal prosecution should focus. Indeed, FDA typically seeks criminal sanctions against a company when a prior warning or other notice is shown, and the noncompliance has continued despite that notice. Moreover, the Federal Sentencing Guidelines for organizations also recognizes that the prior history of an organization may impact the company's compliance program.). My company's noncompliance concerns one of its principal products (If the noncompliance impacts a major product, this increases the visibility and the magnitude of the violation.).

The written questionnaire may end with several background questions, such as an inquiry into the best description of the department the individual works in (for example, either clerical, technical, managerial, research & development, or other). Also, the length of service with the company and the individual's satisfaction with the company may be determined. Finally, other comments may be provided that potentially affect the general scoring of the written questionnaire (individuals with motives to bolster or discredit a company may be discounted by an appropriate factor).

Second, after the written questionnaire, responders will be orally interviewed, without directly attributing statements from the responders in the reports given to the company's management. The reason for having oral interviews is to drill down deeper into compliance issues raised in the written surveys. In some cases, compliance personnel may not be candid. On the one hand, they may overstate compliance concerns to draw management's attention to the compliance function and get more resources for compliance. At the other extreme, they may be fearful of too much attention to the compliance function and understate their concerns. The oral interviews, in either case, are designed to more objectively assess the degree of compliance.

The oral survey will be accompanied by both written instructions to the interviewer, as well as sample questions. The instructions will explain that the purpose of the index's oral survey is two-fold. First, it gives the consultant administering the index an opportunity to drill down more deeply into issues that the written questionnaire raised. In this regard, not only does the oral survey provide an opportunity to gain more information about areas of noncompliance indicated by the responder, but it also provides a chance to clarify inconsistencies and confusions that the written questionnaire brought to light. The instructions may also explain that an interviewer should further explore an area on the written questionnaire in the following circumstances: The interviewee has written comments beside a question in the written questionnaire. The interviewee indicated a strong degree of noncompliance. The interviewee's answers are inconsistent with each other or with others in the company.

Second, the oral survey instructions may explain that the oral survey provides an opportunity to ask more open-ended questions about the company's compliance status, best practices, company culture, and relationship with the regulatory organization. Additionally, the oral survey will provide suggested questions and an interview format for the interviewer, but may explain to the interviewer that he or she should not feel constrained to follow the format of the questions. The following are examples of questions for an oral survey for the device operations of an FDA-regulated company:

Background Questions: What is your title? How long have you been in that position? (If short time, what was prior position, how long there?) What are your specific duties within the company? How would you describe your role with respect to compliance? How does your company organize the regulatory functions at your company? The quality function?

Compliance Questions: Describe your company's compliance status. Describe how your company solves compliance problems. Describe how your company's compliance status has evolved over the past five years. Describe your company's greatest compliance challenges? (Follow up question: What does your company plan to do about those challenges and when?) Describe what your company needs to do to improve its compliance. (Follow up questions: Does your company have plans to make those improvements? If so, what is your timetable for making them?) Does your company have recurring compliance problems or compliance problems in discrete areas? How would you compare your company's compliance to other companies of similar size that make similar products? Do you think your compliance status is better or not as good? Why? How many regulatory and quality staff do you have at the corporate level? At the operating company level? (Follow-up question: Is the number of staff sufficient?) Do the regulatory and compliance staff have the resources that they need to do an effective job? Describe your company's compliance program and initiatives. Are these working? Are these sufficient? What are the strengths and weaknesses of your company's compliance and quality programs? The interviewer will also be instructed to ask follow-up questions regarding compliance based upon the written questionnaire.

Best Practice Questions: Ask follow-up questions regarding best practices based upon the written questionnaire. The seven principal categories of best practices are: Compliance Standards and Procedures; Oversight Responsibility for Compliance; Delegation of Authority for Compliance Standards and Procedures; Communication of Standards and Procedures; Achieving Compliance through Auditing, Monitoring and Reporting; Enforcement of Compliance Standards and Procedures; and Response to a Compliance Offense. Additional categories include: Practices Relating to Corporate Acquisitions; Compliance Resources and Initiatives; Use of Technology to Achieve Compliance; Ongoing Compliance Communication and Updates; Company Incentives for Achieving Compliance; and Interaction with Industry.

Company Culture questions: How does your company achieve a high level of awareness within your company and among its employees about the need for compliance? What has been the most successful tactic for influencing the company's culture with respect to compliance? Are your colleagues knowledgeable about FDA laws and regulations? Describe your top management's views with respect to compliance.

Relationship with FDA questions: What are your company's views generally about FDA? Describe your company's attitudes toward working with FDA. When your company has a compliance problem, how does it interact with FDA to resolve that problem? (Follow-up question: Does your company need to interact more with FDA?) Has your company experienced problems when it has tried to work with FDA to resolve a compliance problem? Describe these problems. Does your company work with FDA to develop new regulatory standards? What could your company do to improve its relationship with FDA? Does your company have a plan for doing this?

Scoring of the company compliance interviews involves first calculating a score for the written questionnaire by calculating an average score for responders on the questions. Individuals in the general corporate category may receive a special weighting (for example, twenty-five percent (25%) of the overall average regardless of the relationship of corporate responses to total responses). The oral survey is scored by the interviewer, who will rate the interviewee's responses on a scale of 1 to 10 for the following factors: the seriousness and volume of the company's known compliance shortcomings; the company's success in adopting best compliance practices; the extent to which the company's culture promotes compliance; and the company's relationship with the regulatory organization. Each of those categories will be weighted the same as the categories of the written questionnaire. A preliminary company interview score is calculated by weighting the written questionnaire scores at, for example, about fifty percent (50%) and the oral interview scores at, for example, about fifty percent (50%) (Clearly the internal company people have the best, most detailed basis for evaluating the company. The external questioner, though, can see conditions more objectively and can more easily compare the company's achievements with industry norms.). Next, the overall candor of the respondents may be evaluated. In the written instrument, candor will be tested by asking the same question different ways, and by asking different people. Moreover, in the oral interviews, the interviewer will form an opinion of the interviewee's candor. Candor is an important prerequisite to having confidence that the information is accurate. A final company compliance interview score is determined by multiplying the total preliminary score by the candor factor. This score may be converted to a quartile scale.

Regulatory Organization Inspection Assessments. The third area in which the index gathers data is assessment conducted by the relevant regulatory organization (which in the exemplary embodiment is the FDA). In theory, because the regulatory organization has the mantle of responsibility to enforce these laws, this could be more important to the issue of compliance than any information that comes from the company itself. On the other hand, the organization's inspectional scope for a given company is usually far narrower than the company's examination of itself. Simply put, it usually represents a very small sliver of the company's compliance picture. The index examines this area by collecting the results of the regulatory organization's inspections for the company, for example, FDA EIR inspections, dividing the inspectional observations into major or minor observations, and aggregating those assessments through a mathematical formula. In this area, it is particularly important to assess the organization's industry-wide practices to determine whether the company got greater or fewer observations than other similarly situated companies.

The regulatory organization inspection assessments (for which the regulatory organization is the FDA) may be allocated about twenty-five percent (25%) of the index evaluation. FDA inspection assessments are an important factor in determining compliance because for a risk to materialize, FDA must first know about the noncompliance. The data in this category are also likely to be more objective than other categories comprising the base score. However, in the index it receives a lower weight than data derived from the company because it almost always represents a far smaller data set than the first two categories in the base score (audits and interviews). It is smaller because FDA inspects much less of a company's operation than does the company itself and because in doing so, FDA only focuses on manufacturing operations.

The type of information relevant to this element of the evaluation includes: How many FDA-registered facilities (including those outside the United States) does the company own? How many FDA inspections have been conducted over the last 3 years? How many observations, both major and minor (in the case of the FDA, these are known as EIRs or 483 observations), issued to the company in that time?

To score this element, the total EIR/483 score calculation is derived according to an appropriate formula. For example, the 483 observations are separated into major and minor, also using EIR if available. If there are any repeated major observations in 483s, these need to be further distinguished (Repeated observations are a red flag for the agency, and are therefore a key risk factor for companies. Thus, the more often an observation occurs, the risk of an enforcement action grows exponentially, not arithmetically.). For example, the first repeat may be assigned a doubled impact. The second repeat a tripled impact, and a third repeat or higher a quadruple impact. The total number of observations are tabulated with minor observations being weighted as one fifth (1/5) of a major observation. This observation total is divided by the number of inspections of the company (whether an inspection produced a 483 or not) and then multiplied by a number equal to the total number of FDA-registered facilities divided by those inspected over the last three years (This number presents the number of facilities not inspected during this three year period. If the company has not been inspected much, this is also an important risk factor for the company for three reasons. First, the company is in a sense “due” for more inspections. Second, the company is more likely to be complacent with regard to compliance. Third, less is known about its compliance status.). This score may be converted to a quartile scale.

Regulatory Quality Data. The final category—regulatory quality data—is comprised of assessments with regard to a company's complaint experience (for devices), its adverse incident reporting experience and its recalls and other corrective actions. In this area, the index collects numeric data not just for the company, but also from the regulatory organization's (here, the exemplary organization being FDA) databases to assess industry averages. On the one hand, these data are compelling indicators of compliance, and FDA relies heavily on these data in deciding where there are compliance issues that need to be examined. On the other hand, these data often do not reflect context, such as the particular technology involved, industry practices with regard to the types of reported events, and the types of events that trigger recalls. Because of this, the index is designed to collect sufficient data to put these quality data into the appropriate context at a high-level.

Regulatory quality data may be allocated about fifteen percent (15%) of the evaluation. This portion of the index will be performed for any company product code that accounts for more than five percent (5%) of company sales, or at least the top five (5) products of the company. For example, for device operations within a company, the index will evaluate the number and character of any complaints for devices over the last three (3) years by FDA product, as well as the number of products sold in that category over the same period (Companies are required to maintain a complaint file pursuant to the quality system regulations. Although the number of complaints is not reported to FDA, they are inspected and may serve as an indicator of a company's compliance for the agency.). Additionally, for medical devices, MDRs may also be included as quality data, with data points including: for each product code evaluated, how many over the last three (3) years; how many products sold in that category over the same period; what is industry average for that product code over that same period, adjusted by known market share (FDA routinely cites MDR data as evidence of the need for enforcement. Additionally, the FDA regulations themselves provide that MRDs will assist FDA in protecting the public health by helping to ensure that devices are not adulterated or misbranded and are safe and effective for their intended use.). With regard to pharmaceutical operations, adverse drug experiences would be evaluated in lieu of MDRs. For all segments of the company, the number and character of recalls and other corrective actions is a relevant data point (FDA routinely cites recall data as evidence of the need for enforcement.). Data points here include: how many individual products recalled over the last three (3) years by product category; how many products sold in that category over the same period; and what is industry average for that product code over that same period, adjusted by known market share.

The methodology for scoring regulatory quality data begins with an industry average score. Then, for device operations within a company, for each category in which the operation's adjusted volume of MDRs (or, for pharmaceutical operations, adverse drug experiences) or recalls is at least fifty percent (50%) over the industry average for all of the studied products for the operation, a point may be added (When considering numbers such as these, FDA typically focuses on deviations from an industry average.). Only a fraction of a point, for example, a half point, will be added if the operation only meets that test for the majority of its products. A point will be subtracted for each category in which the operation's adjusted volume is more than twenty percent (20%) under the industry average for all of the studied products for the operation. Only a fraction of a point, for example, a half point, will be added if the operation only meets that test for the majority of its products. For medical device operations, a point will be added if the ratio of complaints to MDRs is above one hundred fifty (150), and a point will be subtracted if the ratio of complaints to MDRs is less than fifty (50). Finally, the regulatory quality data score may be further adjusted depending on the quality of the company's reporting procedures.

After the four areas of data described above are examined and subscores calculated, they are combined into one overall score, or “base score.” These base scores are used for comparisons across the industry.

A goal in developing the index was to normalize it such that a company's base score may be evaluated based upon quartiles. More specifically, a company's base score and the index itself is expressed in a score from zero (0) to one hundred (100), and the cutoffs of twenty-five (25), fifty (50) and seventy-five (75) are designed to be the cutoffs between the four quartiles among companies. For example, if a company received a base score of less than twenty-five (25), it would be in the lowest (i.e., least compliant) quartile. In this regard, as explained above, the index is most analogous to grading on a curve—it reflects the relative degree of compliance among companies in these industries. However, other scoring schemes may also be employed.

After the base score is determined, the consultant calculating the index develops a risk factor, which is used in a separate calculation to calculate a company's adjusted score. Unlike the elements that go into the base score, the risk factor simply reflects unique circumstances regarding an individual company that affect the risk of noncompliance but that are not a basis for comparing the company to its peers. Although the index collects data on these for an individual company's assessment, for two reasons this data is not entered into the database and is never shared with other companies. First, it is inappropriate to share this kind of information because it could lead to identification of the company. Second, comparisons along these lines do not help a company to assess its risk.

The base score is multiplied by the risk factor to reach a company's adjusted score. The risk factor may be calculated as follows:. Company at average level of risk (for example, 1); Company at greatest risk (for example 0.7, except companies may go lower if there has been a major civil or criminal penalty against the company); Company at least risk (for example 1.3).

This Risk Factor parameter is initially calculated by examining the most significant risk factor, which is civil and criminal penalties and other enforcement actions against the company. A recent civil action or criminal prosecution says quite a bit about the company's risk profile. In the near term, it means that the company's systems were not adequate to prevent noncompliance. When one set of issues within a company has previously lead to an enforcement action, often additional systems are not working appropriately. It also means that FDA will be scrutinizing the company's compliance very closely. Over time, though, this risk factor in many cases ultimately proves to be a risk mitigator because it has a galvanizing effect on company's management to focus much more time, energy, and resources into ensuring compliance. However, companies cannot turn on a dime, and that beneficial effect will typically take years to be fully realized. Thus, enforcement actions and penalties are evaluated by how many there have been over last five (5) years and how long has it been since the last one. Depending on the severity of the violation(s) at issue, a base risk factor score of about 0.5 is accorded if within one (1) year; 0.5 if within two (2) years; 0.6 if within three (3) years; 0.8 if within four (4) years; and 1.0 if within five (5) years.

The risk factor may be decreased (i.e., the company is facing more risk) based on other factors such as warning letters and other business concerns. Warning letters represent the second most significant risk factor because they are often a necessary step before FDA launches a major enforcement action. FDA also has recently tightened its processes to ensure that such letters are reserved for very serious infractions. For warning letters, the following data points are obtained: how many received over last three years; whether recent letters meet a clearer definition of seriousness; the average number received by competitors; the adequacy of the company's response to the letter; and subsequent FDA behavior. Other business concerns that may decrease the risk factor include: The company facing financial difficulties (Companies going through significant financial challenges are on average more likely to have employees who take compliance risks to look better. Additionally, a company may not have the resources necessary to achieve compliance.); Below average amount of staffing (Companies that are thinly staffed are at a higher risk for an enforcement action because there are fewer checks and balances. Additionally, employees are more likely to feel the need to cut corners.); High rate of acquisitions (Small companies often have compliance problems as they prepare their businesses for sale, and companies that purchase them often inherit those problems.); Products use high risk to health technology (When a company's noncompliance impacts the public health, this enhances the risk of an FDA enforcement action. For instance, FDA has recognized that contrary to usual procedure, repetitive or continuous noncompliance may not be a prerequisite for a judicial enforcement action when the noncompliance impacts the public health. Quite simply, FDA focuses its resources where the risk to public health is greatest.); Significant new technology areas for the company (Companies that venture into new areas typically face a steep learning curve, and that learning curve carries greater risk in the interim.); Unusually wide breadth of products (Broad product portfolios will often mean that a company's compliance resources are stretched too thinly, which leads to greater risk of an enforcement action.); Competitors that are likely to complain (This can be a significant source of information about noncompliance for FDA.); and Company size (Being a large company increases the risk of an enforcement action for two reasons. First, FDA typically expects larger companies to have a higher degree of compliance due to their available resources. Second, because of their size, they are simply more visible to the agency and to competitors.).

The Risk Factor may be increased (i.e., the company is facing less risk) if the following are present: The company is very profitable (Companies that are very profitable will have more resources to invest in achieving a high level of compliance.); and Products employ low risk to health technology (FDA typically focuses its resources on technologies that pose the greatest risk to public health.). Also, companies that take the time and expense to achieve certification to standards like ISO and others are typically more likely to be in compliance with FDA requirements. However, this factor can also have the opposite effect. That is, companies may focus so intently on achieving international or other standards that they neglect FDA's regulatory requirements. Thus, this factor will be carefully examined for each company.

In developing this index, great efforts were expended to validate the weights given to the various elements. This validation required considerable analysis of data available from FDA, as well as data available from consultants who are in the business of assessing company compliance. The index was also presented to representatives of the FDA, as well as a variety of people within industry.

A key to the index is the database that is developing over time from companies that participate in the index program. The data resulting from index, when sanitized to remove the company's identity, goes into the database that allows for meaningful comparisons. Over time, as more and more companies participate, that database will become more and more robust, and the comparisons will become more meaningful.

To ensure that companies can utilize the index, and to make the database as robust as possible, a program to certify consultants in the use of the index ensures quality of data. While the index seeks to base the assessment on objective data, without question there is also a substantial component related to the judgment and skill of the administering consultants. To ensure the integrity and quality of the data, the program involves taking applications from consultants and accepting only those who by training and experience possess the necessary qualifications to administer the index effectively. The selected consultants will be required to participate in a training program in which they will learn the nuances of the index calculation and seek to achieve greater standardization of the assessments. For those consultants who successfully complete training, they will be provided with the forms and other tools necessary to perform the assessments.

After a certified consultant completes an assessment leading to an index calculation, the consultant provides the sanitized data coming out of the assessment to a database, thus providing the consultants with an up-to-date analysis of the industry comparisons.

Unlike perhaps some other indices, this index gets into some very sensitive areas. As a result, one of the standard tools that consultants will use is a confidentiality agreement. The confidentiality agreement imposes two sets of obligations. First, it imposes confidentiality obligations on the consultants to protect the data. The agreement spells out the limited uses for the data, which includes providing a specifically defined and sanitized set of data for use in the database. The agreement even goes so far as to specify the amount of data that needs to be in the database before any subanalysis can be conducted. The other set of requirements are imposed on the company itself. Under these requirements, the company must maintain its data as confidential.

Senior management needs an objective measure of its own company's compliance in order to make the right decisions regarding investments and other steps necessary to improve compliance. The right decision starts with the right information, and this index is designed to give the most accurate overall picture possible of that compliance, and to do so in a way that allows meaningful comparisons throughout the industry.

In particular, the index seeks to achieve these meaningful comparisons in three key ways. First, it produces a quantitative and more precise assessment of overall compliance with the laws and regulations administered by a regulatory organization (the exemplary organization being FDA). Thus, in contrast to qualitative measurements that may only tell a company that it has achieved a high or low level of compliance, the index will allow a company to assess its level of compliance as compared across industry. Second, because the index is built in part on data obtained from FDA, it characterizes the seriousness of noncompliance in the agency's eyes. Third, index is unique because the database that is being built based upon the normalization of a company's base scores will ultimately allow companies to evaluate their compliance through extensive industry subanalysis.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. An evaluation method for assessing regulatory compliance of a business entity in an industry regulated by an agency comprising the steps of:
obtaining audit information relating to the business entity;
interviewing personnel of the business entity and recording interview information;
obtaining regulatory information relating to inspection of the business entity by the corresponding agency; and
combining the audit, interview, and regulatory information and scoring that information to create a compliance index related to the efficiency of the regulatory compliance of the business entity.

2. A method of assessing audit information relating to the business entity comprising the steps of:
obtaining audit information related to a business entity;
comparing the audit information of a business entity to a database of audit information from a comparable industry and
a system of assessing the quality of the audit information.

3. The method according to claim 2 further comprising comparing the audit information of a business entity to a database of comparable information maintained by a regulatory agency.

4. The method of claim 3 wherein the regulatory agency is the United Stated Food and Drug Administration.

5. The method of claim 2 where the audit information is input online.

6. The method of claim 2 where the quality of audit information is assessed by unrelated third parties.

7. A method of creating a data base of business entity regulatory compliance information capable of providing a comparative index for individual companies, comprising the steps of:
obtaining audit, interview, and regulatory information related to business entity regulatory compliance for a plurality of business entities;
translating the obtained information into a computer readable format stored in a data base;
determining scoring factors for each portion of the obtained information; and
providing a scoring program for calculating a compliance index for a business entity based on collected data relative to the data base.
